(19) United States
(12) Patent Application Publication
(10) Pub. No.: US 2008/0127352 A1
(43) Pub. Date: May 29, 2008

(54) SYSTEM AND METHOD FOR PROTECTING A REGISTRY OF A COMPUTER

(76) Inventor: Min Wang, Broomfield, CO (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/465,688

(22) Filed: Aug. 18, 2006

(51) Int. Cl. G06F 21/00

(52) U.S. Cl. 726/27

(57) ABSTRACT

A system and method for protecting a registry from pestware or malware is described. One embodiment includes receiving, at a filter, a registry access signal from an application. The registry access signal is rerouted, using the filter, to a virtual registry. The virtual registry corresponds to at least a portion of a registry of a computer that includes an entry related to an operating system (OS) of the computer.

### FIELD OF THE INVENTION

The present invention relates to computer system management. In particular, but not by way of limitation, the present invention relates to systems and methods for protecting a registry from pestware or malware.

### BACKGROUND OF THE INVENTION

Personal computers and business computers are continually attacked by trojans, spyware, and adware, collectively referred to as “malware” or “pestware.” These types of programs generally act to gather information about a person or organization-often without the person or organization's knowledge. Some pestware is highly malicious. Other pestware is non-malicious but may cause issues related to privacy and/or system performance. And yet other pestware is actually beneficial or wanted by the user. Wanted pestware is sometimes not characterized as “pestware” or “spyware.” But, unless specified otherwise, “pestware” as used herein refers to any program that collects and/or reports information about a person or an organization and any “watcher processes” related to the pestware.

Many pestware processes maliciously infiltrate a computer system by altering a registry associated with an operating system of a computer. Because the registry is vital to the functionality of fundamental components/modules of the computer, it is a prime target for many pestware processes. The design and implementation of current and future pestware incorporates techniques, and likely future improvements to them, that are often used to alter a registry of the computer by circumventing pestware detection and removal software and/or hardware modules. For example, pestware can gain access to the registry of a computer using undocumented registry access techniques or cloaking techniques. Accordingly, because current software is not always able to identify, detect, and intercept pestware, current software is not always able to prevent unauthorized modification of a registry.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a system and method for protecting a registry from pestware or malware. In one exemplary embodiment, the present invention includes receiving, at a filter, a registry access signal from an application. The registry access signal is rerouted, using the filter, to a virtual registry. The virtual registry corresponds to at least a portion of a registry of a computer that includes an entry related to an operating system (OS) of the computer.

Another embodiment of the present invention includes accessing a portion of a registry identified as a critical portion of the registry. A portion of a virtual registry that corresponds to the critical portion of the registry is generated and access to the virtual registry is controlled.

In yet another embodiment, a method includes accessing a portion of a registry of a computer that includes an entry related to an operating system (OS) of the computer. A portion of a virtual registry corresponds with the portion of the registry is also accessed. A difference between the portion of the virtual registry and the portion of the registry is identified.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates a schematic block diagram of an implementation of the present invention within a computer system;

FIG. 2 illustrates a method for implementing a virtual registry to protect a critical portion of a registry, according to an embodiment of the invention;

FIG. 3 illustrates a method for creating a virtual registry that can be used to protect a critical portion of a registry, according to an embodiment of the invention; and

FIG. 4 illustrates a method for determining whether a critical portion of the registry should be modified/restored based on entries/keys contained in a virtual registry, according to an embodiment of the invention.

### DETAILED DESCRIPTION

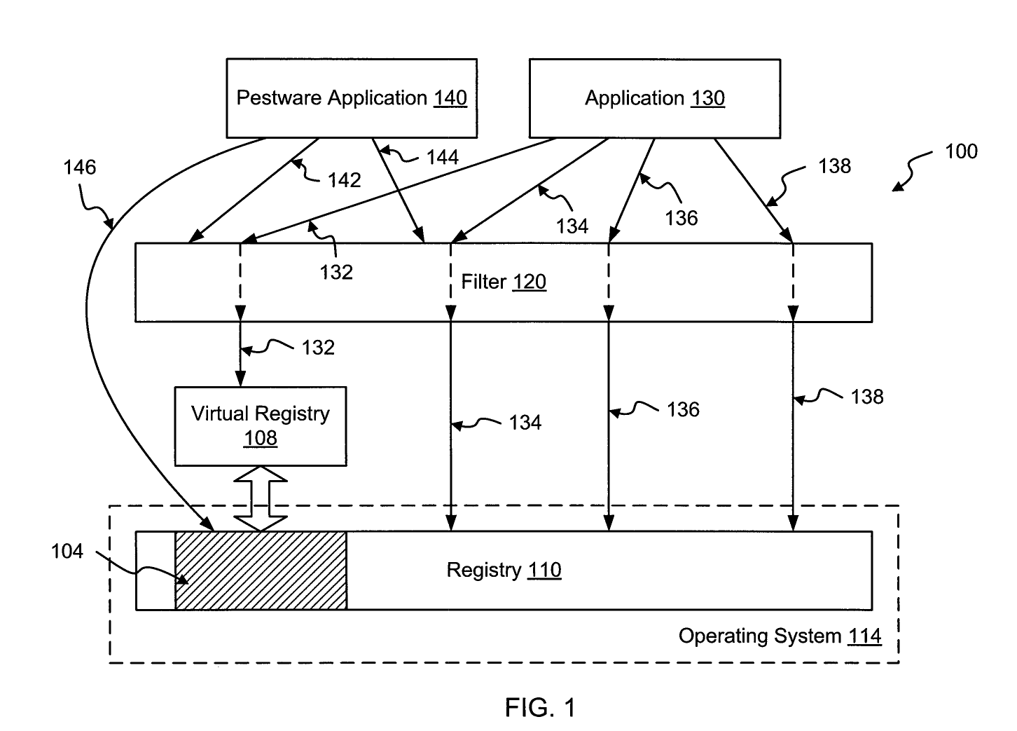

Referring now to the drawings, where like or similar elements are designated with identical reference numerals throughout the several views, and referring in particular to FIG. 1, it illustrates a schematic block diagram 100 of one implementation of the present invention within a computer system. This implementation includes a filter 120 and a virtual registry 108 (also referred to as a customized database) that are collectively configured to protect a registry 110 that is associated with an operating system 114 of a computer system (e.g., the registry 110 includes at least one entry related to the operating system 114). The filter 120 and/or virtual registry 108 are hardware and/or software modules that are associated with and/or integrated into a pestware management application/system (not shown). In other words, the pestware management application/system uses and/or accesses the filter 120 and/or the virtual registry 108 to protect the registry 110 of the computer system.

The filter 120 and/or virtual registry 108 can be designed to operate on any type of computer system (e.g., personal computer or server) including in a WINDOWS and/or Linux-based environment. For convenience, embodiments of the present invention are generally described herein with relation to WINDOWS-based systems. Those of skill in the art can easily adapt these implementations for other types of operating systems or computer systems.

The virtual registry 108 corresponds to a critical portion of the registry 104 and access to the virtual registry 108, like access to the registry 110, is controlled by the filter 120 and/or the pestware management application/system. In many implementations, the virtual registry 108 is an image of the critical portion of the registry 104. The virtual registry 108 is configured so that the critical portion of the registry 104 can be repaired (e.g., restored) using information in the virtual registry 108 when a registry access signal circumvents the filter 120 and accesses and/or alters an entry in the critical portion of the registry 104 in an unauthorized manner (e.g., undocumented registry access signal from a pestware application). In many embodiments, the virtual registry 108 is a secure virtual registry (e.g., encrypted) with restricted access that is controlled by the filter 120.

The critical portion of the registry 104 is a set of keys/entries that are pre-defined by, for example, a user or software developer. The critical portion of the registry 104 includes, for example, keys that allow the operating system 114 to load an application implicitly and/or automatically; keys that are used to install a device driver or service; keys that should be used only by the operating system 114; and/or keys that belong to and should only be accessed by a security application such as a pestware management application. A definition of the keys that should be included as critical portions of the registry 104 is configurable (e.g., can be updated with additional keys and/or portions of keys) and stored so that the virtual registry 108 will be created based on that definition.

One of ordinary skill in the art will appreciate that the critical portion of the registry 104 and the virtual registry 108 are depicted as single portions or blocks for convenience in this Detailed Description. In many implementations, the critical portion of the registry 104 and/or the virtual registry 108 can be separated into more than one block (e.g., separate pieces or locations in memory).

As shown in FIG. 1, registry access signals 132-138 and registry access signals 142-146 originate at an application 130 and a pestware application 140, respectively. The application 130 is an application that is authorized to access the registry 110 and the pestware application 140 is an application that is not authorized to access the registry 110.

The filter 120 (also referred to as a filter driver, hook filter, or registry filter) is configured to intercept registry access signals (e.g., application program interface (API) calls) such as those originating at application 130 and/or pestware application 140 to enable a determination to be made as to whether the registry access signals should be denied or routed to either the registry 110 or the virtual registry 108. In some embodiments, the filter 120 controls access to and from the registry 110 and virtual registry 108 such that communication being facilitated and/or monitored by the filter 120 is transparent to pestware application 140 and application 130. In many implementations, the filter 122 is realized by a kernel mode driver that may be loaded during a boot sequence of the operating system 114.

In some embodiments, the filter 120 is configured to authenticate all registry access signals that trigger access to the registry 110 and/or virtual registry 108 to ensure that the registry access signals are not from the pestware application 140 before allowing access (e.g., read/write/delete access). For example, the filter 120 itself may analyze whether registry access signals are associated with a potential-pestware process.

In other embodiments, the filter 120 is configured to intercept the registry access signals and then communicate with a pestware management application/system (e.g., a user-mode pestware management application), which analyzes whether the registry access signals are associated with a potential-pestware process. In these other embodiments, the filter 120 may wait for the pestware management application/system to assess whether the registry access signals pose a threat before allowing or denying access to the registry 110.

More details related to intercepting registry access signals (e.g., using a kernel-mode driver) are set forth in commonly assigned and co-pending application Ser. No. 11/257,609, Attorney Docket No. WEBR-015/00US, filed Oct. 25, 2005, entitled System and Method for Kernel-Level Pestware Management which is incorporated herein by reference.

An analysis of whether registry access signals are associated with pestware (e.g., the pestware application) may include, for example, one or more of the following techniques: a definition-based analysis, a heuristics-based analysis, or an offset scanning analysis. More details related these types of analysis may be found in the following commonly assigned and co-pending applications: application Ser. No. 10/956,574, filed Oct. 1, 2004. Attorney Docket No. WEBR-005/00US, entitled System and Method for Pestware Detection and Removal; application Ser. No. 11/237,291, filed Sep. 28, 2005. Attorney Docket No. WEBR-020/00US, entitled Client Side Exploit Tracking; and application Ser. No. 11/105,977, filed Apr. 4, 2005. Attorney Docket No. WEBR-014/00US, entitled System and Method for Scanning Memory for Petsware Offset Signatures, which are incorporated herein by reference.

As shown in FIG. 1, registry access signals 134-138 are directed by the filter 120 to the appropriate location in the registry 110 because they are originating at application 130, which is authorized to access the registry 110. Additional details related to intercepting and forwarding registry access signals may be found in the above-identified application entitled System and Methodfor Kernel-Level Pestware Management. The registry 110 can then be read/write/deleted according to the registry access signals 134-138. On the other hand, because registry access signals 142-144 are registry access signals from pestware application 140, which is not authorized to access the registry 110, these registry access signals 142-144 are denied access to the registry 110 (and the virtual registry 108) by the filter 120.

Registry access signal 132 is a registry access signal from application 130 that is directed/targeted to a location in the critical portion of the registry 104. FIG. 1 shows that registry access signal 132 is redirected (e.g., rerouted) from accessing the critical portion of the registry 104 to an entry/location in the virtual registry 108 that corresponds with the critical portion of the registry 104. In some embodiments, the filter 120 controls access to and from the virtual registry 108 such that application 130 does not detect that registry access signal 132 and all subsequent communication through the filter 120 is with a virtual registry 108 rather than the critical portion of the registry 104.

FIG. 1 shows a registry access signal 146 from pestware application 140 that circumvents the filter 120. Because registry access signal 146 is, for example, an undocumented and/or an unauthorized registry access signal, filter 120 does not intercept registry access signal 146. Although the registry access signal 146 may access and/or modify the critical portion of the registry 104 without authorization, the virtual registry 108 can be used to restore any portions of the critical portion of the registry 104 that should not have been modified.

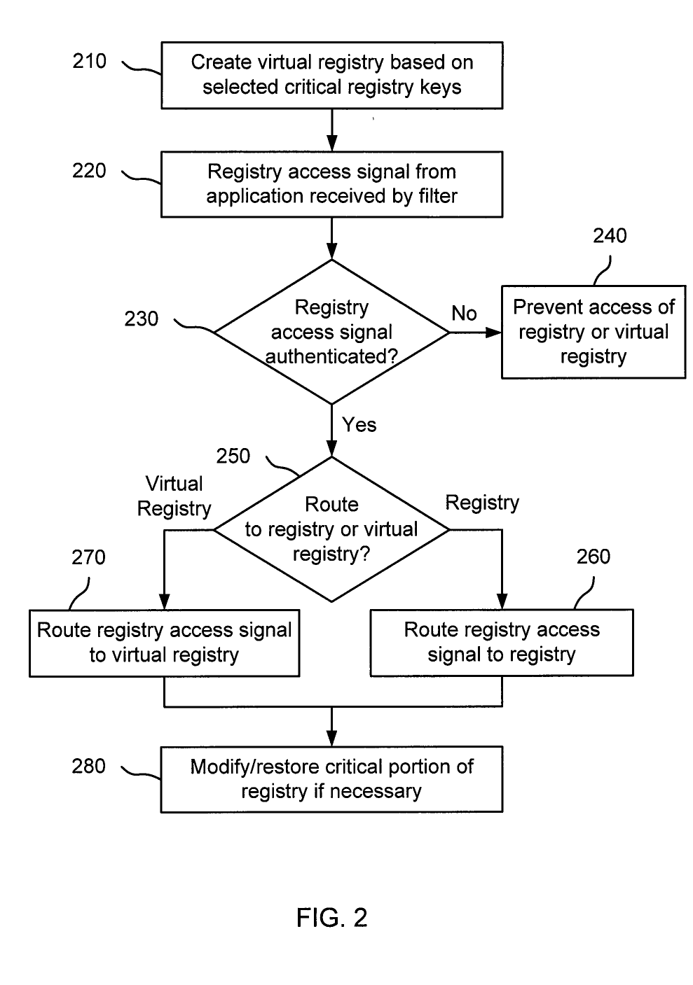

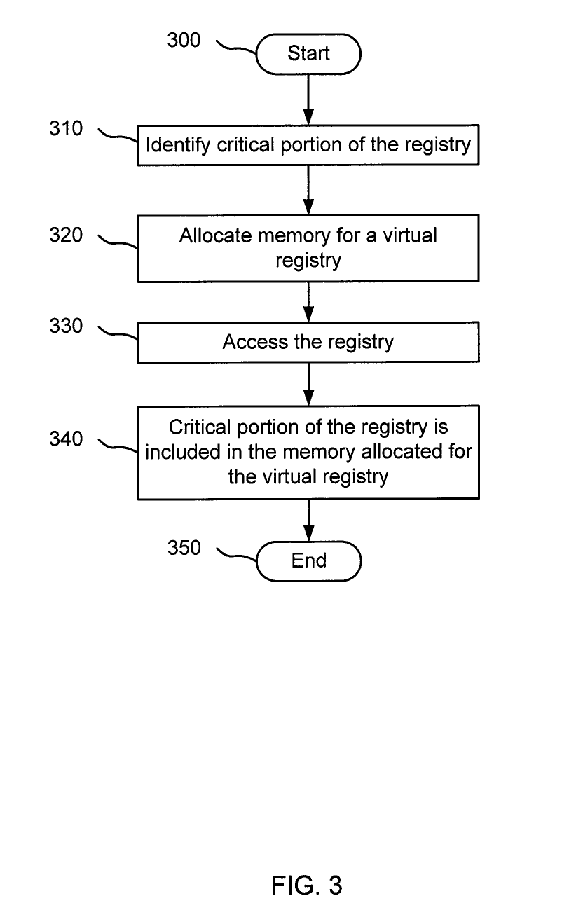

FIG. 2 illustrates a method for implementing a virtual registry to protect a critical portion of a registry. First, a virtual registry is created based on selected critical registry keys (block 210). A method for creating a virtual registry is described in more detail below in connection with FIG. 3.

After the virtual registry has been created, a registry access signal from an application is received (block 220). The registry access signal is intercepted by, for example, a filter before the registry access signal accesses or triggers the accessing of the registry. The registry access signal is, in some embodiments, a registry access request and in some embodiments, the registry access signal is an instruction, indicator, and/or command that will be used to directly or indirectly access the registry. For example, in some embodiments, the registry access signal triggers a separate program to access and/or send information associated with the registry.

The registry access signal is then analyzed by the filter to determine if the registry access signal is authorized (e.g., authenticated) to access the registry (block 230). If the registry access signal is not authenticated by the filter, access to the registry or virtual registry is denied (block 240).

If the registry access signal is authenticated, the filter determines whether or not the registry access signal should be routed to the registry or the virtual registry (block 250). The registry access signal is routed to the target location in the registry (block 260) when the target of the registry access signal is a location in the registry that has not been selected as a critical portion of the registry. The registry access signal is routed to a location in the virtual registry that corresponds with the critical portion of the registry (block 270) when the target of the registry access signal is a location in the critical portion of the registry.

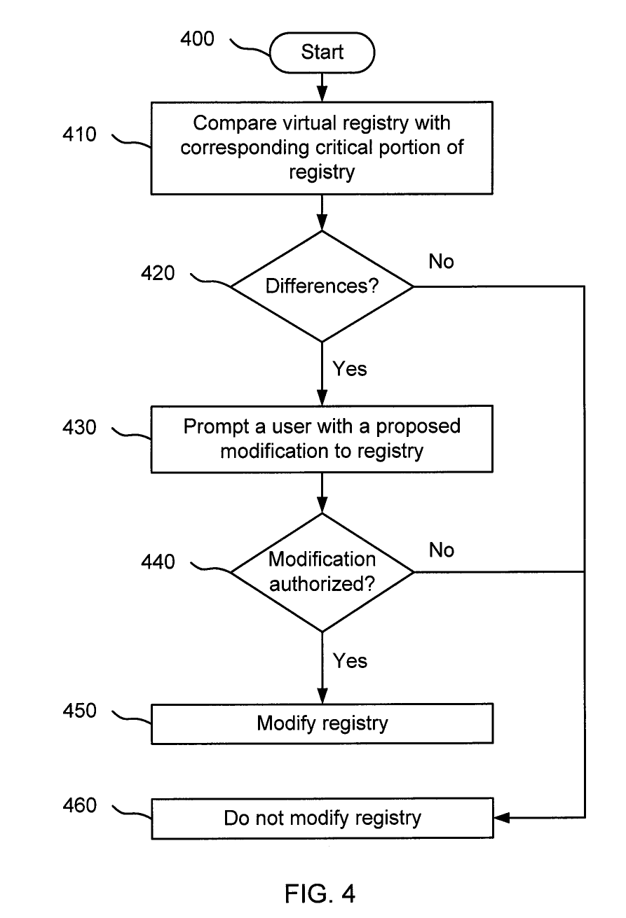

As shown in FIG. 2, the critical portion of the registry is accessed to determine whether or not a modification/restoration of the critical portion of the registry is necessary (block 280). A method for determining whether or not to modify the critical portion of the registry is described in more detail below in connection with FIG. 4.

Although the embodiment shown in FIG. 2 illustrates a particular order for blocks 210-280, the order illustrated in the flowchart is by way of example only and the blocks and/or steps within blocks do not have be executed in a particular order or at a particular time. In some embodiments, for example, blocks 220-270 are executed iteratively and blocks 210 and 280 are executed during boot time (e.g., early boot time) and during shut-down of a computer system, respectively. For example, critical portions of the registry can be modified/restored (block 280) based on the virtual registry at any point or at multiple points in the flowchart.

FIG. 3 illustrates a method for creating a virtual registry that can be used to protect a critical portion of a registry. This method or portions of this method can be executed during, for example, installation of software that will access/use the virtual registry; during a boot-up sequence (e.g., early boot time); after a user has logged on; and/or just before the virtual registry will be accessed.

A critical portion of the registry that is to be protect is identified (block 310). The critical portion can be defined by, for example, a user, an application, or a software developer interested in protecting the critical portion of the registry. The critical portion of the registry can include one or more keys/entries that, for example, relate to an operating system, device and/or module installation, security application, etc. A list/database of the critical portion(s) of the registry can be uploaded to and/or stored on, for example, a computer system for use in creating a virtual registry. The list/database can be uploaded from a remote computer or installed on a computer system during, for example, a software installation of a pestware application that will use the list/database of the critical portion(s) of the registry to create a virtual registry. In some embodiments, the critical portions of the registry are user specific (e.g., different lists of critical registry entries for each user).

As shown in FIG. 3, after the critical portion of the registry has been identified/defined, at least one location in memory is allocated for a virtual registry (block 320). The memory is allocated for the virtual registry by, for example, a filter or a pestware management system/application using a memory allocation technique provided by, for example, WINDOWS. In some embodiments, the virtual registry space is allocated and/or entirely controlled by a filter program and/or a pestware management system/application. The memory can be in any location, such as physical memory, that is accessible and/or secured by the filter.

After space for the critical portion of the registry has been allocated, the registry is accessed (block 330) and the critical portion of the registry is included in the memory allocated for the virtual registry (block 340). In some embodiments, a copy of the critical portion of the registry is included in the memory. In some implementations, a look-up table that can be used to associate locations within the critical portion of the registry with locations in the virtual registry is stored in the allocated memory.

Although not illustrated in FIG. 3, in some embodiments, additional critical portion(s) of the registry are defined and the virtual registry is updated and/or modified based on the additional critical portion(s) of the registry. In some implementations, portion(s) of the virtual registry are also removed if, for example, a portion of the registry that was previously identified as critical is removed from, for example, a definition of critical portions of the registry. In some variations of the invention, the virtual registry or portions of the virtual registry are generated only when a critical portion of the registry will be accessed by an application. In other words, portions of the virtual registry or the entire virtual registry are created in real-time.

FIG. 4 illustrates a method for determining whether a critical portion of the registry should be modified/restored based on entries/keys contained in a virtual registry. The method shows that the virtual registry is compared with the corresponding critical portion of the registry (block 410) to determine whether there are differences between the virtual registry and the critical portion of the registry (block 420).

The difference is the result of changes made to the critical portion of the registry or changes made to the virtual registry. For example, the difference can be the result of unauthorized changes to the critical portion of the registry by a registry access signal that accessed the critical portion of the registry in an unauthorized manner (e.g., by circumventing a filter associated with a pestware management system). The difference can also be, for example, a result of changes to the virtual registry that were authorized by a filter. The comparison is executed using a one-to-one comparison of, for example, corresponding bits or using identifiers associated with the virtual registry and/or the critical portion of the registry that indicate a difference.

The critical portion of the registry is not modified (block 460) when a difference between the virtual registry and the critical portion of the registry is not detected. In some embodiments, a user can be notified that a critical portion of the registry has not been modified.

When a difference between the virtual registry and the critical portion of the registry is detected, a user is prompted with a proposed modification to the registry (block 430) and the user responds to indicate whether or not the modification is authorized (block 440). When the modification is not authorized by the user, the critical portion of the registry is not modified (block 460). If the modification is authorized by the user, the registry is modified (block 450) based on the proposed modification (block 430).

In some embodiments, changes that were authorized and made to the virtual registry are automatically copied into the critical portion of the registry without authorization from a user. A filter and/or a pestware management system can be configured to log authorized changes to the virtual registry to make this determination. In some embodiments, a user is only given the option to authorize a modification to the critical portion of the registry, for example, if the changes were made by registry access requests that circumvented a filter or were not authorized by the filter. If, for example, multiple unrelated differences are detected, a user can be prompted to authorize each of the differences separately and modifications can be made separately.

In some embodiments, the method illustrated in FIG. 4 is executed periodically during operation of a computer system (e.g., a virtual registry is periodically re-imaged, flashed, or synchronized with the critical portion of the registry), and in other embodiments, the virtual registry is compared with the critical portion of the registry and/or updated only when, for example, the computer system is being shut down.

In conclusion, the present invention provides, among other things, a system and method for protecting a registry from pestware or malware. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method, comprising:
receiving, at a filter, a registry access signal from an application; and
rerouting, using the filter, the registry access signal to a virtual registry, the virtual registry corresponds to at least a portion of a registry of a computer, the registry includes an entry related to an operating system (OS) of the computer.

2. The method of claim 1, further comprising routing the registry access signal to the filter.

3. The method of claim 1, further comprising authenticating the registry access signal using the filter.

4. The method of claim 3, wherein the authenticating includes identifying a process associated with the registry access signal and includes analyzing whether the process is a potential pestware process.

5. The method of claim 4, wherein the analyzing includes analyzing using at least one of a definition-based analysis, a heuristics-based analysis and an offset scanning analysis.

6. The method of claim 1, wherein the virtual registry includes a virtual registry entry that corresponds to a registry entry from the registry identified as a critical registry entry.

7. The method of claim 1, wherein the registry access signal is configured to trigger at least one of reading, deleting, or modifying a portion of the registry.

8. The method of claim 1, wherein the rerouting to the virtual registry includes rerouting to a location within the virtual registry that corresponds to a location within the registry.

9. The method of claim 1, wherein the rerouting to the virtual registry includes routing to a location within the virtual registry when a target location of the registry access signal is a location within the registry that corresponds with the location within the virtual registry.

10. The method of claim 1, wherein the virtual registry is a secure virtual registry.

11. The method of claim 1, wherein the registry access signal is an application program interface call.

12. A method, comprising:
accessing a portion of a registry identified as a critical portion;
generating a portion of a virtual registry that corresponds to the critical portion of the registry; and
controlling access to the virtual registry.

13. The method of claim 12, wherein the controlling includes controlling using a filter.

14. The method of claim 12, further comprising allocating a location in a memory for the portion of the virtual registry, the generating includes saving the portion of the virtual registry in the allocated memory location.

15. The method of claim 12, wherein the critical portion of the registry includes at least one of a registry entry that enables an operating system (OS) to load an application, a registry entry associated with an installation of an application, a registry entry associated exclusively with an OS, and a registry entry associated with a security application.

16. The method of claim 12, further comprising rerouting, using a filter, a registry access signal to the portion of the virtual registry,
the registry access signal being routed to the critical portion of the registry before the rerouting.

17. The method of claim 12, further comprising routing a registry access signal to a portion of the registry identified as a non-critical portion.

18. The method of claim 12, further comprising authenticating a registry access signal.

19. The method of claim 12, wherein the identifying includes identifying during a boot-up sequence.

20. The method of claim 12, wherein the generating includes generating during a boot-up sequence.

21. A method comprising:
accessing a portion of a registry of a computer, the registry includes an entry related to an operating system (OS) of the computer;
accessing a portion of a virtual registry corresponding with the portion of the registry; and
identifying a difference between the portion of the virtual registry and the portion of the registry.

22. The method of claim 21, sending a request to modify the registry based on the difference.

23. The method of claim 21, further comprising modifying the registry based on the difference.

24. The method of claim 21, wherein the difference is a result of at least one of an unauthorized modification to the registry by a pestware application or an authorized modification to the virtual registry by an application.
